(19) United States
(12) Patent Application Publication
(10) Pub. No.: US 2022/0204682 A1
(43) Pub. Date: Jun. 30, 2022

(54) BIO-POLYOL COMPOSITION, FOAM COMPOSITION, AND FOAM MATERIAL

(71) Applicant: INDUSTRIAL TECHNOLOGY RESEARCH INSTITUTE, Hsinchu (TW)

(72) Inventors: Wen-Pin CHUANG, Hsinchu City (TW); Yi-Che SU, Zhubei City (TW); Chia-Ling WEN, Miaoli County (TW)

(73) Assignee: INDUSTRIAL TECHNOLOGY RESEARCH INSTITUTE, Hsinchu (TW)

(21) Appl. No.: 17/135,742

(22) Filed: Dec. 28, 2020

(51) Int. Cl. C08G 18/64; C08G 18/32; C08G 18/50

(52) U.S. Cl. CPC C08G 18/6492; C08G 2101/00; C08G 18/5024; C08G 18/3206

(57) ABSTRACT

A bio-polyol composition, a foam composition, and a foam material are provided. The bio-polyol composition includes 25-70 parts by weight of lignin; 30-75 parts by weight of non-amine-based polyol; and, 2-17 parts by weight of amine-based polyether polyol. In particular, the sum of the weight of the lignin and the non-amine-based polyol is 100 parts by weight.

### TECHNICAL FIELD

The disclosure relates to a bio-polyol composition, a foam composition, and a foam material

### BACKGROUND

In nature, lignin reserves are second only to cellulose, and about 50 billion tons are produced globally each year. Lignin is abundant and cheap and has great business potential, and lignin has polyaromatic ring structure which leads to good mechanical properties and chemical resistance, and is therefore very suitable for use in the development of bio-composite materials. However, the application of internationally-developed biomaterials (such as lignin) in polymer composite materials is still very limited, mainly due to the large number of —OH functional groups and benzene ring structures of the lignin and strong intermolecular forces (such as hydrogen bonding) and π-π attraction force. Lignin therefore does not readily disperse in a polymer substrate, and as a result a greater amount of it causes the mechanical properties to worsen. Only the uniform dispersion of lignin in a polymer substrate can effectively improve the mechanical properties of the bio-composite material and reduce the cost. Therefore, the mixing and dispersion of lignin and the modification technique thereof are among the most important techniques to be established in the domestic industry.

Currently, the development of lignin for application in polymer composite material is still very limited. If lignin is directly mixed with polyol for foaming, since the dispersibility and the stability of lignin in polyurethane (PU) are poor, a greater amount of it causes the compressive strength to worsen and yields a foam material with broken foam cell walls.

Accordingly, a novel method for applying lignin in polymer composite material is desired for solving the aforementioned problems.

### SUMMARY

The disclosure provides a bio-polyol composition. According to embodiments of the disclosure, the bio-polyol composition includes 25-70 parts by weight of lignin; 30-75 parts by weight of non-amine-based polyol, wherein the total weight of the lignin and the non-amine-based polyol is 100 parts by weight; and, 2-17 parts by weight of amine-based polyether polyol.

According to embodiments of the disclosure, the disclosure also provides a foam composition. According to embodiments of the disclosure, the foam composition can include the bio-polyol composition of the disclosure and an isocyanate compound.

According to embodiments of the disclosure, the disclosure also provides a foam material. According to embodiments of the disclosure, the foam material is a product of the foam composition of the disclosure subjected to a foaming process.

A detailed description is given in the following embodiments.

### DETAILED DESCRIPTION

The bio-polyol composition, a foam composition, and a foam material of the disclosure are described in detail in the following description. In the following detailed description, for purposes of explanation, numerous specific details and embodiments are set forth in order to provide a thorough understanding of the present disclosure. The specific elements and configurations described in the following detailed description are set forth in order to clearly describe the present disclosure. It will be apparent, however, that the exemplary embodiments set forth herein are used merely for the purpose of illustration, and the inventive concept may be embodied in various forms without being limited to those exemplary embodiments. As used herein, the term “about” in quantitative terms refers to plus or minus an amount that is general and reasonable to persons skilled in the art.

As used herein, the term “about” in quantitative terms refers to plus or minus an amount that is general and reasonable to persons skilled in the art.

Moreover, the use of ordinal terms such as “first”, “second”, “third”, etc., in the disclosure to modify an element does not by itself connote any priority, precedence, or order of one claim element over another or the temporal order in which it is formed, but are used merely as labels to distinguish one claim element having a certain name from another element having the same name (but for use of the ordinal term) to distinguish the claim elements.

The disclosure provides a bio-polyol composition. Since the bio-polyol composition includes the lignin with a specific amount ratio, the non-amine-based polyol, and the amine-based polyether polyol, the lignin can be uniformly dispersed in the non-amine-based polyol and amine-based polyether polyol. Therefore, the lignin can be also uniformly dispersed in the polyurethane foam material after subjecting a foam composition (including the bio-polyol composition) to a foaming process. As a result, the obtained foam material exhibits a higher foaming ratio and enhanced mechanical properties and flame retardancy. In addition, since the bio-polyol composition of the disclosure including the amine-based polyether polyol, and the amine-based polyether polyol has an OH value of 200 mg KOH/g to 500 mg KOH/g, the foam reactivity of the foam composition can be controlled (for example the polymerization rate of the foam composition can be increased), thereby improving the foaming ratio (greater than about 23) of the foam material, maintaining the integrity of the foam cell walls, and reducing the thermal conductivity coefficient of the obtained foam material (less than or equal to about 0.04 W/mK). As a result, the foam material of the disclosure meets the thermal insulation requirements of commercial polyurethane foam material.

According to embodiments of the disclosure, the disclosure provides a bio-polyol composition. the bio-polyol composition includes about 25-70 parts by weight (such as about 30 parts by weight, 35 parts by weight, 40 parts by weight, 45 parts by weight, 50 parts by weight, 55 parts by weight, 60 parts by weight, or 65 parts by weight) of lignin; about 30-75 parts by weight (such as about 35 parts by weight, 40 parts by weight, 45 parts by weight, 50 parts by weight, 55 parts by weight, 60 parts by weight, 65 parts by weight, or 70 parts by weight) of non-amine-based polyol (i.e. the first polyol), wherein the total weight of the lignin and the non-amine-based polyol is 100 parts by weight; and, about 2-17 parts by weight (such as about 3 parts by weight, 4 parts by weight, 5 parts by weight, 6 parts by weight, 7 parts by weight, 8 parts by weight, 9 parts by weight, 10 parts by weight, 11 parts by weight, 12 parts by weight, 13 parts by weight, 14 parts by weight, 15 parts by weight, or 16 parts by weight) of amine-based polyether polyol (i.e. the second polyol).

According to embodiments of the disclosure, due to the addition of the amine-based polyether polyol with specific chemical structure, hydroxyl value and amount in the bio-polyol composition of the disclosure, the lignin in the polyurethane formed via a subsequent foaming process exhibits improved dispersibility and stability. As a result, the additional amount of lignin in the bio-polyol composition can be increased (for example the amount of lignin can be greater than equal to 25 wt % (such as about 25 wt % to 70 wt %, based on the total weight of the lignin and non-amine-based polyol). As a result, the foaming ratio of the foam material can be improved (for example the foam material may have a foaming ratio greater than about 23) and the integrity of the foam cell walls may be maintained, thereby increasing the compressive strength of the obtained foam material and reducing the thermal conductivity coefficient (less than or equal to about 0.04 W/mK) of the obtained foam material.

According to embodiments of the disclosure, the lignin of the disclosure can be lignosulfonate, alkaline lignin, organosolv lignin, phenol-modified lignin, or a combination thereof.

According to embodiments of the disclosure, the lignin can be non-modified lignin, such as lignosulfonate, alkaline lignin, or a combination thereof.

According to embodiments of the disclosure, the lignin can be modified lignin. For example, the lignosulfonate or alkaline lignin can be modified with a modifier. According to embodiments of the disclosure, the modifier can be alcohol with hydroxyl group or epoxy group, epoxy resin or a combination thereof. According to embodiments of the disclosure, the modifier can be polyol, such as dihydric alcohol, trihydric alcohol, tetrahydric alcohol or a combination thereof. For example, the modifier can be ethylene glycol, polypropylene glycol (PPG), dipropylene glycol (DPG), or glycerol. In case of dihydric alcohol having two terminal hydroxyl groups (—OH), one of the two terminal hydroxyl groups can attach the surface of the lignin to improve the dispersibility of the lignin (i.e. the modified lignin surface) and the other terminal hydroxyl group (—OH) can be further reacted with a compound.

According to embodiments of the disclosure, the structure of modified lignin can be L [symbol] O—R^{a})ₖ, wherein L is a residual moiety of lignin eliminating k number of terminal hydroxyl groups; R^{a} is C₁₋₄ alkyl group, phenyl group,

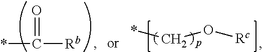

R^{a} is connected to oxygen atom by the location represented by *; R^{b} and R^{c} are independently C₁₋₄ alkyl group; and, p is 1, 2, 3 or 4; and, 3<k≤10. According to embodiments of the disclosure, the C₁₋₄ alkyl group can be linear or branched alkyl group. For example, C₁₋₄ alkyl group can be methyl, ethyl, propyl, butyl, or an isomer thereof.

According to embodiments of the disclosure, the particle size of lignin can be about 1 μm to 100 μm, such as about 5 μm, 10 μm, 20 μm, 30 μm, 40 μm, 50 μm, 60 μm, 70 μm, 80 μm, or 90 μm. When the particle size of lignin is larger than 100 μm, the lignin is apt to be settle resulting in stratification of the composition. In addition, when the particle size of lignin is less than 1 μm, the uneven distribution of the lignin in the obtained foam material is caused due to the high viscosity of lignin.

According to embodiments of the disclosure, the non-amine-based polyol can be a polyol without amine group. According to embodiments of the disclosure, the non-amine-based polyol can be a polyol without nitrogen atom. According to embodiments of the disclosure, the non-amine-based polyol and the amine-based polyether polyol are distinct from each other. According to embodiments of the disclosure, the non-amine-based polyol can be dihydric alcohol, trihydric alcohol, tetrahydric alcohol or a combination thereof. According to embodiments of the disclosure, the non-amine-based polyol can be polyester polyol, polyether polyol, C₂₋₁₄ polyol, or a combination thereof. According to embodiments of the disclosure, the non-amine-based polyol can be poly(ethylene adipate) diol, poly(1,4-butylene adipate) diol, poly(ethylene dodecanoate) diol, poly(1,6-hexathylene adipate) diol, polyethylene glycol (PEG), polypropylene glycol (PPG), polytetramethylene ether glycol (PTMEG), ethylene glycol, 1,3-propylene glycol, glycerol, 1,4-butylene glycol, 1,5-pentylene glycol, neo-pentylene glycol, 1,6-hexylene glycol, 1,7-heptylene glycol, 1,8-octylene glycol, 1,9-nonylene glycol, decylene glycol, undecylene glycol, dodecylene glycol, tetradecylene glycol, isosorbide, 2,5-furandiol, or a combination thereof. According to embodiments of the disclosure, when the non-amine-based polyol is polyester polyol or polyether polyol, the weight average molecular weight (Mw) of non-amine-based polyol can be about 500 to 100,000, such as 600 to 80,000, 1000 to 60,000, 2,000 to 50,000, or 5,000 to 40,000. The weight average molecular weight (Mw) of the non-amine-based polyol of the disclosure is determined by gel permeation chromatography (GPC) based on a polystyrene calibration curve.

According to embodiments of the disclosure, the amine-based polyether polyol of the disclosure is polyol with amino moiety. According to embodiments of the disclosure, the amine-based polyether polyol of the disclosure can be aromatic-amine-based polyether polyol, aliphatic-amine-based polyether polyol, or a combination thereof. According to embodiments of the disclosure, the amine-based polyether polyol can have a structure of Formula (I)

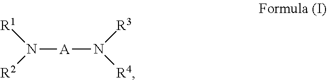

wherein A is C₂₋₁₂ alkylene group,

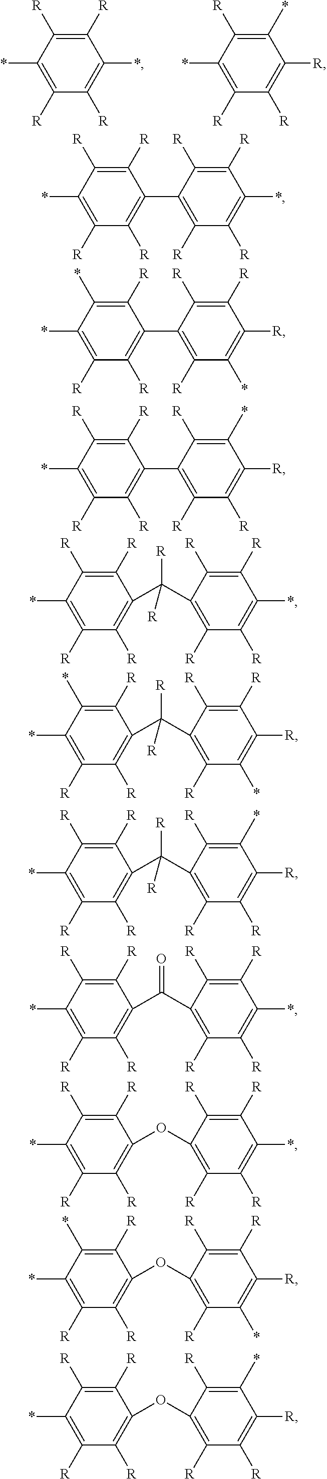

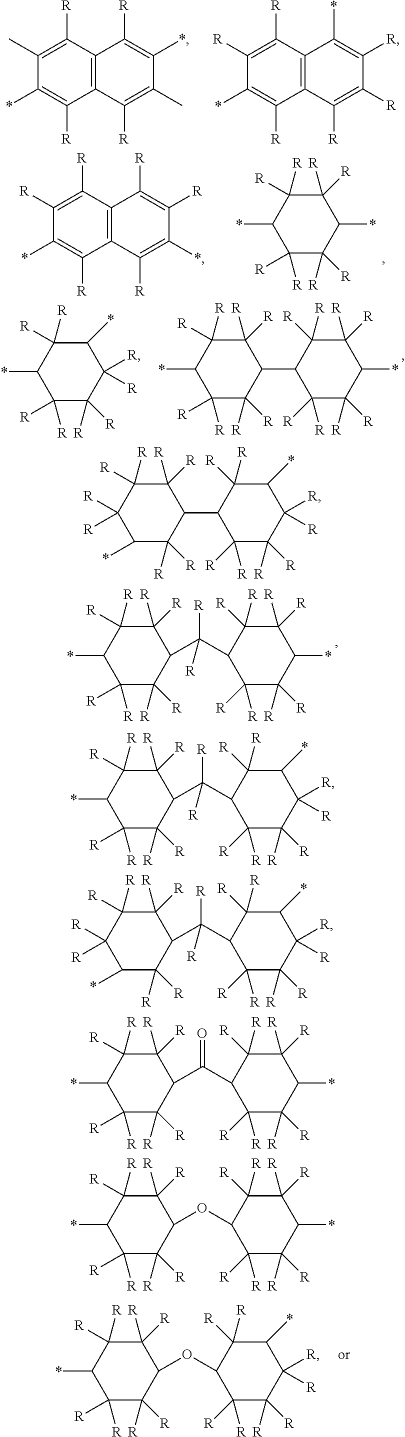

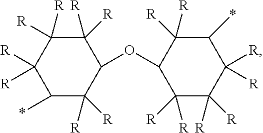

wherein A is connected to nitrogen by the location represented by *; R is independently hydrogen, fluorine, C₁₋₄ alkyl group, or C₁₋₄fluoroalkyl group; i is 1, 2, or 3; R¹, R², R³, and R⁴ are independently hydrogen, C₂₋₁₂ alkylol group, or

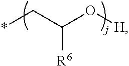

wherein at least two of R¹, R², R³, and R⁴ are C₂₋₁₂ alkylol group or

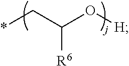

j≥2 (such as 200≥j≥2, 180≥j≥2, 160≥j≥2, 150≥j≥2, 140≥j≥2, 120≥j≥2, 100≥j≥2, 80≥j≥2, 70≥j≥2, 60≥j≥2, 50≥j≥2, 40≥j≥2, 30≥j≥2, or 25≥j≥2); R⁵ are independently hydrogen, methyl or ethyl; and, R⁶ are independently hydrogen, methyl or ethyl.

According to embodiments of the disclosure, at least two of R¹, R², R³, and R⁴ can be

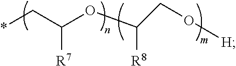

n≥1 (such as 200≥n≥2, 180≥n≥2, 160≥n≥2, 150≥n≥2, 140≥n≥2, 120≥n≥2, 100≥n≥2, 80≥n≥2, 70≥n≥2, 60≥n≥2, 50≥n≥2, 40≥n≥2, 30≥n≥2, or 20≥n≥2); m≥1 (such as 200≥m≥2, 180≥m≥2, 160≥m≥2, 150≥m≥2, 140≥m≥2, 120≥m≥2, 100≥m≥2, 80≥m≥2, 70≥m≥2, 60≥m≥2, 50≥m≥2, 40≥m≥2, 30≥m≥2, or 25≥m≥2); R⁷ is hydrogen, methyl, or ethyl; and, R⁸ is hydrogen, methyl, or ethyl, wherein R⁷ and R⁸ are different.

According to embodiments of the disclosure, C₂₋₁₂ alkylene group can be linear or branched alkylene group. For example, C₂₋₁₂ alkylene group can be propylene group, butylene group, pentylene group, hexylene group, heptylene group, octylene group, or an isomer thereof. According to embodiments of the disclosure, C₁₋₄ fluoroalkyl group can be an alkyl group which a part of or all hydrogen atoms bonded on the carbon atom are replaced with fluorine atoms, and C₁₋₄ fluoroalkyl group can be linear or branched, such as fluoromethyl, fluoroethyl, fluoropropyl, fluorobutyl, or an isomer thereof. Herein, fluoromethyl group can be monofluoromethyl group, difluoromethyl group or tetrafluoromethyl group, and fluoroethyl can be monofluoroethyl group, difluoroethyl group, trifluoroethyl group, tetrafluoroethyl, or perfluoroethyl. According to embodiments of the disclosure, C₂₋₁₂ alkylol group can be linear or branched alkylol group. For example, C₂₋₁₂ alkylol group can be ethylol, propylol, butylol, or an isomer thereof.

According to embodiments of the disclosure, the amine-based polyether polyol can have a hydroxyl value of 200 mgKOH/g to 500 mgKOH/g. When the hydroxyl value of amine-based polyether polyol is too low, the bio-polyol composition would have reduced reactivity, thereby yielding the foam material with broken foam cell walls. When the hydroxyl value of amine-based polyether polyol is too high, the foam material exhibits low foaming ratio due to the accelerated gelation resulting from the high reactivity of the amine-based polyether polyol, thereby further increasing the thermal conductivity coefficient of the obtained foam material. The amount of amine-based polyether polyol can be 2 wt % to 17 wt % (such as about 3 wt %, 4 wt %, 5 wt %, 6 wt %, 7 wt %, 8 wt %, 9 wt %, 10 wt %, 11 wt %, 12 wt %, 13 wt %, 14 wt %, 15 wt %, or 16 wt %), based on the total weight of the lignin and the non-amine-based polyol. Namely, when the total weight of the lignin and the non-amine-based polyol is 100 parts by weight, the amine-based polyether polyol is 2 parts by weight to 17 parts by weight. When the amount of amine-based polyether polyol is too low or too high, the foaming ratio of the obtained foam material cannot be increased and the thermal conductivity coefficient of the obtained foam material cannot be reduced. According to embodiments of the disclosure, the foaming ratio of the obtained foam material can be improved and the thermal conductivity coefficient of the obtained foam material can be reduced by adjusting the amount of amine-based polyether polyol and maintaining the hydroxyl value of the amine-based polyether polyol in a specific range.

According to embodiments of the disclosure, the bio-polyol composition can consist of the lignin, the non-amine-based polyol and the amine-based polyether polyol. According to embodiments of the disclosure, the lignin can be uniformly dispersed in the non-amine-based polyol and the amine-based polyether polyol by a grinding and dispersing process, obtaining the bio-polyol composition of the disclosure. By means of the grinding and dispersing process, the particle size of lignin can be reduced and the non-amine-based polyol and amine-based polyether polyol can cover the surface of lignin effectively, thereby further reducing the surface energy of the lignin.

According to embodiments of the disclosure, the bio-polyol composition of the disclosure is suitable for use in concert with an isocyanate compound to prepare a foam composition, wherein the foam composition can be used in a foaming process for preparing a foam material. According to embodiments of the disclosure, the foam composition includes aforementioned bio-polyol composition and isocyanate compound. According to embodiments of the disclosure, the isocyanate compound includes aliphatic diisocyanate, aromatic diisocyanate, or a combination thereof. According to embodiments of the disclosure, the isocyanate compound can be hexamethylene diisocyanate (HDI), methylene diphenyl diisocyanate (MDI), toluene diisocyanate (TDI), isophorone diisocyanate (IPDI), 1,5-naphthalene diisocyanate (NDI), p-phenylene diisocyanate (PPDI), or a combination thereof. According to embodiments of the disclosure, the composition can include two or more than two isocyanate compounds. According to embodiments of the disclosure, the weight ratio of the isocyanate compound to the total weight of the lignin, non-amine-based polyol, and amine-based polyether polyol of the bio-polyol composition is about 0.9 to 1.2.

According to embodiments of the disclosure, the foam composition of the disclosure can optionally further include a surfactant, in order to increase the dispersibility of the lignin and improve the compatibility and reactivity of the ingredients of the foam composition. The amount of surfactant can be optionally modified by a person of ordinary skill in the field, but not limited to. According to embodiments of the disclosure, the amount of surfactant can be about 0.1 wt % to 20 wt %, based on the total weight of the lignin, non-amine-based polyol, amine-based polyether polyol and isocyanate compound.

According to embodiments of the disclosure, the surfactant can be siloxane-polyether surfactant or silicone surfactant. According to embodiments of the disclosure, the surfactant can have a structure of Formula (II)

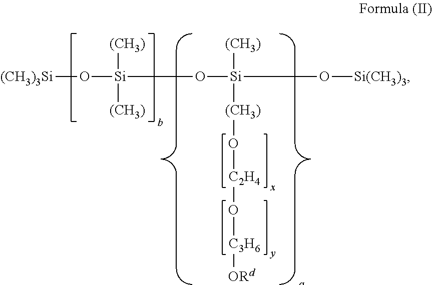

wherein R^{d} is hydrogen or C₁₋₄alkyl group; x≥5 (such as 100≥x≥5); y≥1 (such as 20≥y≥1); x/y is 5 to 13; a is an integer from 1 to 100; b is an integer from 1 to 100.

According to embodiments of the disclosure, the foam composition of the disclosure can optionally further include a catalyst, in order to increase the reactivity of the foam composition during the subsequent foaming process. According to embodiments of the disclosure, the catalyst can be organometallic catalysts (such as organic bismuth catalyst, organic tin catalyst), amine catalyst (such as quaternary amine catalyst), or a combination thereof. The amount of catalyst can be optionally modified by a person of ordinary skill in the field, but not limited to. According to embodiments of the disclosure, the amount of catalyst can be about 0.01 wt % to 5 wt %, based on the total weight of the lignin, non-amine-based polyol, amine-based polyether polyol and isocyanate compound.

According to embodiments of the disclosure, the foam composition of the disclosure can optionally further include additives, such as thermal stabilizer, photo-stabilizer, softener, plasticizer (such as citric acid, or citric acid ester), dye, pigment, antioxidant, ultraviolet absorber, filler (such as calcium carbonate, mica, or wood fiber), antistatic agent, impact modifier, or a combination thereof. The amount of additive can be optionally modified by a person of ordinary skill in the field, but not limited to. According to embodiments of the disclosure, the amount of each additive can be about 0.01 wt % to 50 wt %, based on the total weight of the lignin, non-amine-based polyol, amine-based polyether polyol and isocyanate compound.

According to embodiments of the disclosure, the disclosure also provides a foam material, which is prepared from the aforementioned foam composition via a foaming process. According to embodiments of the disclosure, the foam material can be a biomass polyurethane foam material. According to embodiments of the disclosure, the foam cell pore size of foam material can be controlled in a range of 200 μm to 2100 μm (such as 400 μm to 600 μm). According to embodiments of the disclosure, the foaming ratio of foam material can be greater than about 23, and the thermal conductivity coefficient of foam material can be less than or equal to about 0.04 W/mK.

According to embodiments of the disclosure, the foaming process can be mechanical foaming, physical foaming, or chemical foaming. The foaming process can be performed in the presence of a blowing agent according to various foaming process. According to embodiments of the disclosure, the blowing agent can be organic thermal decomposition type blowing agent, and the organic thermal decomposition type blowing agent can be N,N′-dinitrosopentamethylenetetramine, azodicarbonamide, p,p′-p,p′-oxybisbenzenesulfonylhydrazide, p-toluenesulfonylhydrazide, benzenesulfonylhydrazide, 3,3′-disulfonylhydrazide diphenylsulfone, toluenesulfonyl semicarbazide, trihydrazinotriazine, or a combination thereof, but not limited to. In addition, the blowing agent can be inorganic thermal decomposition type blowing agent, and the inorganic thermal decomposition type blowing agent can be sodium hydrogen carbonate, potassium hydrogen carbonate, ammonium hydrogen carbonate, sodium carbonate, ammonium carbonate, or a combination thereof, but not limited to. According to embodiments of the disclosure, when performing a physical foaming process to form the foam material, a supercritical fluid cam be employed. The supercritical fluid can be carbon dioxide, water, methane, ethane, butane, propane, pentane, cyclopentane, hexane, ethylene, propylene, methanol, ethanol, acetone, methyl ethyl ketone, dichloromethane, nitrogen gas, or a combination thereof. The amount of blowing agent can be optionally modified by a person of ordinary skill in the field, but not limited to. According to embodiments of the disclosure, the amount of blowing agent can be 0.1 wt % to 500 wt %, based on the total weight of the lignin, non-amine-based polyol, amine-based polyether polyol and isocyanate compound.

According to embodiments of the disclosure, the foam composition of the disclosure can consist of the bio-polyol composition and the isocyanate compound. According to embodiments of the disclosure, the foam composition of the disclosure can consist of a main ingredient and a minor ingredient, wherein the main ingredient can consist of the bio-polyol composition and isocyanate compound. The minor ingredient can consist of the surfactant and blowing agent. According to embodiments of the disclosure, the foam composition of the disclosure can substantially consist of bio-polyol composition, and isocyanate compound, and the optional ingredients can be surfactant, blowing agent, thermal stabilizer, photo-stabilizer, softener, plasticizer (such as citric acid, or citric acid ester), dye, pigment, antioxidant, ultraviolet absorber, filler (such as calcium carbonate, mica, or wood fiber), antistatic agent, impact modifier. According to embodiments of the disclosure, the foam composition of the disclosure can substantially consist of bio-polyol composition, isocyanate compound, and blowing agent, the optional ingredients can be surfactant, blowing agent, thermal stabilizer, photo-stabilizer, softener, plasticizer (such as citric acid, or citric acid ester), dye, pigment, antioxidant, ultraviolet absorber, filler (such as calcium carbonate, mica, or wood fiber), antistatic agent, impact modifier. According to embodiments of the disclosure, due to the addition of the bio-polyol composition (including specific ingredients and amounts) of the disclosure, the foam composition of the disclosure can achieve the technical purpose for improving foam material foaming ratio and reducing foam material thermal conductivity coefficient in the absence of surfactant (i.e. the foam composition of the disclosure does not include a surfactant).

According to embodiments of the disclosure, the method for preparing the foam material of the disclosure may include the following steps. First, the bio-polyol composition of the disclosure (the bio-polyol composition can be obtained via a grinding and dispersing process) is provided. Next, the bio-polyol composition and diisocyanate (or diisocyanate and other ingredients (such as aforementioned surfactant, catalyst, blowing agent)) are provided, obtaining a foam composition. Next, the foam composition is subjected to a foaming process and a blowing agent may be employed as appropriate. After curing, the foam material of the disclosure is obtained.

Below, exemplary embodiments will be described in detail so as to be easily realized by a person having ordinary knowledge in the art. The inventive concept may be embodied in various forms without being limited to the exemplary embodiments set forth herein. Descriptions of well-known parts are omitted for clarity, and like reference numerals refer to like elements throughout.

### EXAMPLES

### Example 1

First, 55.1 parts by weight of alkali lignin (with a weight average molecular weight (Mw) about 1000 to 1500, extracted from rice husk), 44.9 parts by weight of polypropylene glycol (with a molecular weight about 400), and 3.6 parts by weight of amine-based polyether polyol (commercially available from Jiangsu Luyuan New Material Co., Ltd under a trade number of FQ-450) (prepared from hexamethylenediamine, ethylene oxide, and propylene oxide; i.e., in the Formula (I), A was hexylene group; R¹, R², R³, and R⁴ were hydrogen, or a residual moiety of polyether polyol (having repeating units of

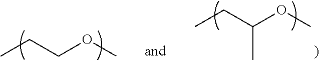

eliminating hydrogen; and, the hydroxyl value was about 450 mgKOH/g)) were mixed, obtaining a mixture. Next, the mixture was subjected to a grinding and dispersing process via a disperser (DAS 200, LAU GmbH) for 30 minutes, obtaining Bio-polyol composition (1). Next, Bio-polyol composition (1), 1.45 parts by weight of surfactant (commercially available from Evonik under a trade number of TEGOSTAB® B 8870), 0.07 parts by weight of catalyst (commercially available from Evonik under a trade number of DABCO® T-12), and 110.2 parts by weight of methylene diphenyl diisocyanate (MDI) were mixed, obtaining Foam composition (1). Next, Foam composition (1) was subjected to a foaming process with 7 parts by weight of blowing agent (i.e. water), obtaining Foam material (1).

### Example 2

First, 55.9 parts by weight of alkali lignin (with a weight average molecular weight (Mw) about 1000 to 1500, extracted from rice husk), 44.1 parts by weight of polypropylene glycol (with a molecular weight about 400), and 7.1 parts by weight of amine-based polyether polyol (commercially available from Jiangsu Luyuan New Material Co., Ltd under a trade number of FQ-450; prepared from hexamethylenediamine, ethylene oxide, and propylene oxide; i.e., in the Formula (I), A was hexylene group; R¹, R², R³, and R⁴ were hydrogen, or a residual moiety of polyether polyol (having repeating units of and

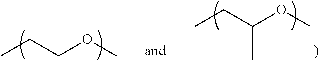

eliminating hydrogen; and, the hydroxyl value was about 450 mgKOH/g)) were mixed, obtaining a mixture. Next, the mixture was subjected to a grinding and dispersing process via a disperser for 30 minutes (DAS 200, LAU GmbH), obtaining Bio-polyol composition (2). Next, Bio-polyol composition (2), 1.43 parts by weight of surfactant (commercially available from Evonik under a trade number of TEGOSTAB® B 8870), 0.07 parts by weight of catalyst (commercially available from Evonik under a trade number of DABCO® T-12), and 111.2 parts by weight of methylene diphenyl diisocyanate (MDI) were mixed, obtaining Foam composition (2). Next, Foam composition (2) was subjected to a foaming process with 8.1 parts by weight of blowing agent (i.e. water), obtaining Foam material (2).

### Example 3

First, 59.9 parts by weight of alkali lignin (with a weight average molecular weight (Mw) about 1000 to 1500, extracted from rice husk), 40.1 parts by weight of polypropylene glycol (with a molecular weight about 400), and 10.0 parts by weight of amine-based polyether polyol (commercially available from Jiangsu Luyuan New Material Co., Ltd under a trade number of FQ-450; prepared from hexamethylenediamine, ethylene oxide, and propylene oxide; i.e., in the Formula (I), A was hexylene group; R¹, R², R³, and R⁴ were hydrogen, or a residual moiety of polyether polyol (having repeating units of and

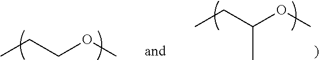

eliminating hydrogen; and, the hydroxyl value was about 450 mgKOH/g)) were mixed, obtaining a mixture. Next, the mixture was subjected to a grinding and dispersing process via a disperser for 30 minutes (DAS 200, LAU GmbH), obtaining Bio-polyol composition (3). Next, Bio-polyol composition (3), 1.3 parts by weight of surfactant (Commercially available from Evonik under a trade number of TEGOSTAB® B 8870), 0.06 parts by weight of catalyst (commercially available from Evonik under a trade number of DABCO® T-12), and 124.2 parts by weight of methylene diphenyl diisocyanate (MDI) were mixed, obtaining Foam composition (3). Next, Foam composition (3) was subjected to a foaming process with 8.7 parts by weight of blowing agent (i.e. water), obtaining Foam material (3).

### Example 4

First, 62.3 parts by weight of alkali lignin (with a weight average molecular weight (Mw) about 1000 to 1500, extracted from rice husk), 37.7 parts by weight of polypropylene glycol (with a molecular weight about 400), and 12.3 parts by weight of amine-based polyether polyol (commercially available from Jiangsu Luyuan New Material Co., Ltd under a trade number of FQ-450; prepared from hexamethylenediamine, ethylene oxide, and propylene oxide; i.e., in the Formula (I), A was hexylene group; R¹, R², R³, and R⁴ were hydrogen, or a residual moiety of polyether polyol (having repeating units of and

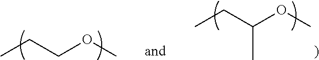

eliminating hydrogen; and, the hydroxyl value was about 450 mgKOH/g)) were mixed, obtaining a mixture. Next, the mixture was subjected to a grinding and dispersing process via a disperser for 30 minutes (DAS 200, LAU GmbH), obtaining Bio-polyol composition (4). Next, Bio-polyol composition (4), 1.2 parts by weight of surfactant (Commercially available from Evonik under a trade number of TEGOSTAB® B 8870), 0.06 parts by weight of catalyst (commercially available from Evonik under a trade number of DABCO® T-12), and 133.5 parts by weight of methylene diphenyl diisocyanate (MDI) were mixed, obtaining Foam composition (4). Next, Foam composition (4) was subjected to a foaming process with 9.1 parts by weight of blowing agent (i.e. water), obtaining Foam material (4).

### Example 5

First, 52.8 parts by weight of alkali lignin (with a weight average molecular weight (Mw) about 1000 to 1500, extracted from rice husk), 47.2 parts by weight of polypropylene glycol (with a molecular weight about 400), and 5.8 parts by weight of amine-based polyether polyol (commercially available from Wanhua Chemical Group Co., Ltd under a trade number of WANOL R2430M; prepared from hexamethylenediamine, ethylene oxide, and propylene oxide; i.e., in the Formula (I), A was hexylene group; R¹, R², R³, and R⁴ were hydrogen, or a residual moiety of polyether polyol (having repeating units of and

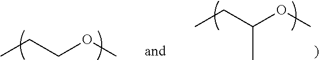

eliminating hydrogen; and, the hydroxyl value was about 290 mgKOH/g)) were mixed, obtaining a mixture. Next, the mixture was subjected to a grinding and dispersing process via a disperser for 30 minutes (DAS 200, LAU GmbH), obtaining Bio-polyol composition (5). Next, Bio-polyol composition (5), 1.51 parts by weight of surfactant (commercially available from Evonik under a trade number of TEGOSTAB® B 8870), 0.07 parts by weight of catalyst (commercially available from Evonik under a trade number of DABCO® T-12), and 116.2 parts by weight of methylene diphenyl diisocyanate (MDI) were mixed, obtaining Foam composition (5). Next, Foam composition (5) was subjected to a foaming process with 7.6 parts by weight of blowing agent (i.e. water), obtaining Foam material (5).

### Example 6

First, 58.0 parts by weight of alkali lignin (with a weight average molecular weight (Mw) about 1000 to 1500, extracted from rice husk), 42.0 parts by weight of polypropylene glycol (with a molecular weight about 400), and 10.4 parts by weight of amine-based polyether polyol (commercially available from Wanhua Chemical Group Co., Ltd under a trade number of WANOL R2430M; prepared from hexamethylenediamine, ethylene oxide, and propylene oxide; i.e., in the Formula (I), A was hexylene group; R¹, R², R³, and R⁴ were hydrogen, or a residual moiety of polyether polyol (having repeating units of and

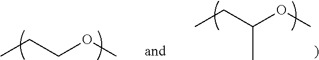

eliminating hydrogen; and, the hydroxyl value was about 290 mgKOH/g)) were mixed, obtaining a mixture. Next, the mixture was subjected to a grinding and dispersing process via a disperser for 30 minutes (DAS 200, LAU GmbH), obtaining Bio-polyol composition (6). Next, Bio-polyol composition (6), 1.34 parts by weight of surfactant (commercially available from Evonik under a trade number of TEGOSTAB® B 8870), 0.06 parts by weight of catalyst (commercially available from Evonik under a trade number of DABCO® T-12), and 116.6 parts by weight of methylene diphenyl diisocyanate (MDI) were mixed, obtaining Foam composition (6). Next, Foam composition (6) was subjected to a foaming process with 8.4 parts by weight of blowing agent (i.e. water), obtaining Foam material (6).

### Example 7

First, 62.6 parts by weight of alkali lignin (with a weight average molecular weight (Mw) about 1000 to 1500, extracted from rice husk), 37.4 parts by weight of polypropylene glycol (with a molecular weight about 400), and 14.3 parts by weight of amine-based polyether polyol (commercially available from Wanhua Chemical Group Co., Ltd under a trade number of WANOL R2430M; prepared from hexamethylenediamine, ethylene oxide, and propylene oxide; i.e., in the Formula (I), A was hexylene group; R¹, R², R³, and R⁴ were hydrogen, or a residual moiety of polyether polyol (having repeating units of and

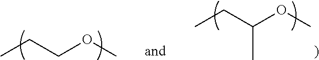

eliminating hydrogen; and, the hydroxyl value was about 290 mgKOH/g)) were mixed, obtaining a mixture. Next, the mixture was subjected to a grinding and dispersing process via a disperser for 30 minutes (DAS 200, LAU GmbH), obtaining Bio-polyol composition (7). Next, Bio-polyol composition (7), 1.19 parts by weight of surfactant (commercially available from Evonik under a trade number of TEGOSTAB® B 8870), 0.05 parts by weight of catalyst (commercially available from Evonik under a trade number of DABCO® T-12), and 131.2 parts by weight of methylene diphenyl diisocyanate (MDI) were mixed, obtaining Foam composition (7). Next, Foam composition (7) was subjected to a foaming process with 9.0 parts by weight of blowing agent (i.e. water), obtaining Foam material (7).

### Comparative Example 1

First, 35.4 parts by weight of alkali lignin (with a weight average molecular weight (Mw) about 1000 to 1500, extracted from rice husk) and 64.6 parts by weight of polypropylene glycol (with a molecular weight about 400) were mixed, obtaining a mixture. Next, the mixture was subjected to a grinding and dispersing process via a disperser for 30 minutes (DAS 200, LAU GmbH), obtaining Bio-polyol composition (8). Next, Bio-polyol composition (8), 1.89 parts by weight of surfactant (commercially available from Evonik under a trade number of TEGOSTAB® B 8870), 0.09 parts by weight of catalyst (commercially available from Evonik under a trade number of DABCO® T-12), and 107.8 parts by weight of methylene diphenyl diisocyanate (MDI) were mixed, obtaining Foam composition (8). Next, Foam composition (8) was subjected to a foaming process with 3.2 parts by weight of blowing agent (i.e. water), obtaining Foam material (8).

Next, the foaming ratio and thermal conductivity coefficient of the obtained foam materials prepared from Examples 1-7 and Comparative Example 1, the results are shown in Table 1. The foaming ratio was determined by densitometry. In detail, the method for determining the foaming ratio can include the following steps. First, the foam material was cut to form a test piece (with a length of 5 cm, width of 5 cm, thickness of lcm, and a volume of 25 cm³), and the test piece was weighed. Next, the density (D) of the test piece was measured, and the foaming ratio was the reciprocal of D (i.e. 1/D) (with a numerical value represented by cm³/g). The thermal conductivity coefficient was determined by thermoconductivity analyzer (TPS 2500, Hot Disc AB, Sweden) according to ISO-D IS22007 (based on transient plane source method).

TABLE 1

| | lignin and non- | | hydroxyl value of | | thermal |
|---|---|---|---|---|---|
| | amine-based | amine-based | amine-based | | conductivity |
| | polyether polyol | polyether polyol | polyether polyol | foaming | coefficient |
| | (parts by weight) | (parts by weight) | (mgKOH/g) | ratio | (W/mK) |
| Example 1 | 100 | 3.6 | 450 | 25.49 | 0.037 |
| Example 2 | 100 | 7.1 | 450 | 24.9 | 0.032 |
| Example 3 | 100 | 10.0 | 450 | 25.19 | 0.029 |
| Example 4 | 100 | 12.3 | 450 | 23.5 | 0.031 |
| Example 5 | 100 | 5.8 | 290 | 24.21 | 0.037 |
| Example 6 | 100 | 10.4 | 290 | 24.72 | 0.036 |
| Example 7 | 100 | 14.3 | 290 | 25.04 | 0.034 |
| comparative | 100 | 0 | — | 7.65 | 0.048 |
| example 1 | | | | | |

Foam material (8) of Comparative Example 1 was prepared from a foam composition without amine-based polyether polyol. In comparison with Comparative Example 1, since the foam compositions in Examples 1-7 includes amine-based polyether polyol, the obtained foam material exhibits obviously high foaming ratio and obviously low thermal conductivity coefficient. In addition, as shown in Table 1, the foam material of disclosure has a foaming ratio greater than 23 and a thermal conductivity coefficient less than 0.04 W/mK resulting from controlling the amount of amine-based polyether polyol within a specific range.

### Comparative Example 2

Comparative Example 2 was performed in the same manner as the method for preparing Foam material (1) in Example 1, except that the amount of amine-based polyether polyol was reduced from 3.6 parts by weight to about 1.5, obtaining Foam material (9). Foam material (9) was observed using a scanning electron microscope (SEM), and the result clearly shows that the number of foam cells and the foam cell pore size of Foam material (9) are reduced. Further, Foam material (9) has broken foam cell walls. It results from the polymerizing rate being reduced due to the low additional amount of amine-based polyether polyol. As a result, the foam material exhibits reduced foaming ratio and increased thermal conductivity coefficient.

### Comparative Example 3

Comparative Example 2 was performed in the same manner as the method for preparing Foam material (7) in Example 7, except that the amount of amine-based polyether polyol was increased from 14.3 parts by weight to about 18, obtaining Foam material (10). Foam material (10) was observed by scanning electron microscopy (SEM), and the result clearly shows that the number of foam cells and the foam cell pore size of Foam material (10) are reduced. Further, Foam material (10) has broken foam cell walls. It results from the polymerizing rate being increased due to the high additional amount of amine-based polyether polyol. As a result, the foam material exhibits reduced foaming ratio and increased thermal conductivity coefficient.

It will be clear that various modifications and variations can be made to the disclosed methods and materials. It is intended that the specification and examples be considered as exemplary only, with the true scope of the disclosure being indicated by the following claims and their equivalents.

What is claimed is:

1. A bio-polyol composition, comprising:
25-70 parts by weight of lignin;
30-75 parts by weight of non-amine-based polyol, wherein the total weight of the lignin and the non-amine-based polyol is 100 parts by weight; and
2-17 parts by weight of amine-based polyether polyol.

2. The bio-polyol composition as claimed in claim 1, wherein the amine-based polyether polyol has a hydroxyl value of 200 mg KOH/g to 500 mg KOH/g.

3. The bio-polyol composition as claimed in claim 1, wherein the lignin comprises lignosulfonate, alkaline lignin, organosolv lignin, phenol-modified lignin, or a combination thereof.

4. The bio-polyol composition as claimed in claim 1, wherein the non-amine-based polyol is polyester polyol, polyether polyol, C₂₋₁₄ polyol, or a combination thereof.

5. The bio-polyol composition as claimed in claim 1, wherein the non-amine-based polyol is poly(ethylene adipate) diol, poly(1,4-butylene adipate) diol, poly(ethylene dodecanoate) diol, poly(1,6-hexathylene adipate) diol, polyethylene glycol (PEG), polypropylene glycol (PPG), polytetramethylene ether glycol (PTMEG), ethylene glycol, 1,3-propylene glycol, glycerol, 1,4-butylene glycol, 1,5-pentylene glycol, neo-pentylene glycol, 1,6-hexylene glycol, 1,7-heptylene glycol, 1,8-octylene glycol, 1,9-nonylene glycol, decylene glycol, undecylene glycol, dodecylene glycol, tetradecylene glycol, isosorbide, 2,5-furandiol, or a combination thereof.

6. The bio-polyol composition as claimed in claim 1, wherein the amine-based polyether polyol is aromatic-amine-based polyether polyol, aliphatic-amine-based polyether polyol, or a combination thereof.

7. The bio-polyol composition as claimed in claim 1, wherein the amine-based polyether polyol has a structure represented by Formula (I) 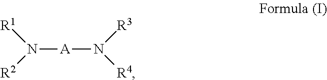
wherein A is C₂₋₁₂ alkylene group, 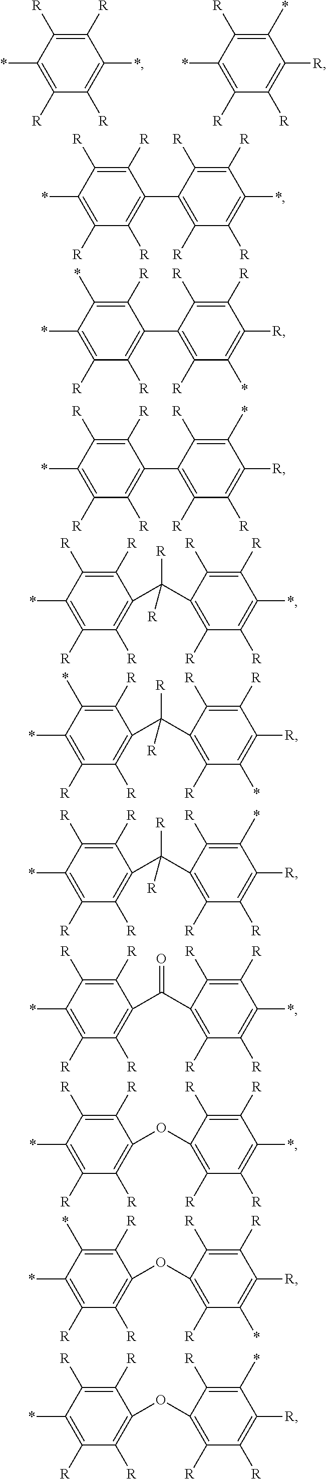 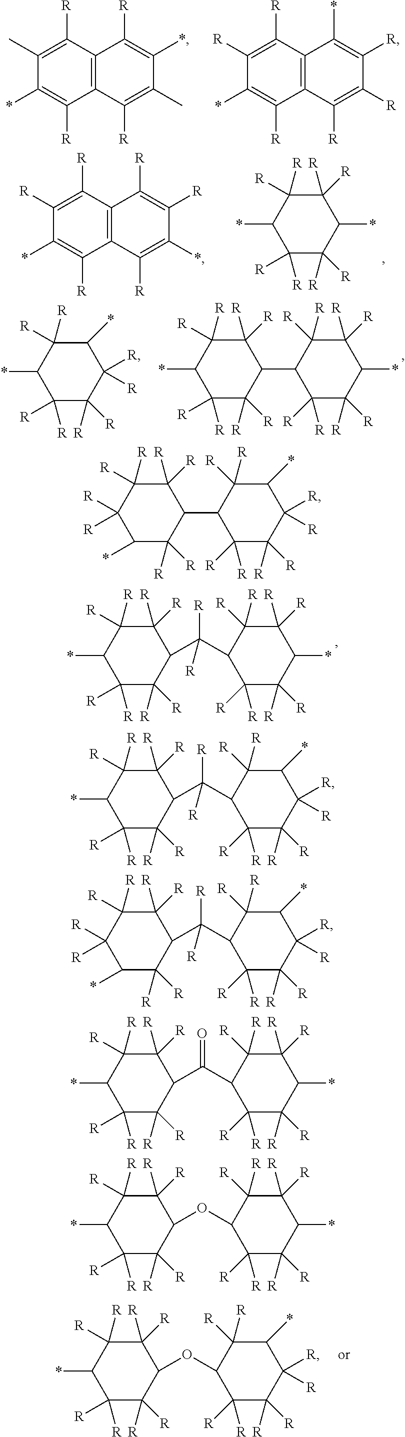 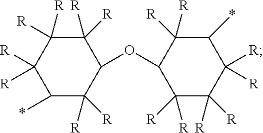
R is independently hydrogen, fluorine, C₁₋₄alkyl group, or C₁₋₄fluoroalkyl group; i is 1, 2, or 3; R¹, R², R³, and R⁴ are independently hydrogen, C₂₋₁₂ alkylol group, or 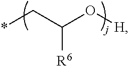
wherein at least two of R¹, R², R³, and R⁴ are C₂₋₁₂ alkylol group or 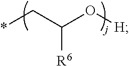
j≥2; R⁵ are independently hydrogen, methyl or ethyl; and, R⁶ are independently hydrogen, methyl or ethyl.

8. The bio-polyol composition as claimed in claim 7, wherein at least two of R¹, R², R³, and R⁴ are 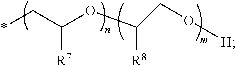
n≥1; m≥1; R⁷ is hydrogen, methyl, or ethyl; and, R⁸ is hydrogen, methyl, or ethyl, wherein R⁷ and R⁸ are different.

9. A foam composition, comprising:
the bio-polyol composition as claimed in claim 1; and
an isocyanate compound.

10. The foam composition as claimed in claim 9, wherein the ratio of the weight of isocyanate compound to the total weight of the lignin, non-amine-based polyol, and amine-based polyether polyol is 1 to 1.2.

11. The foam composition as claimed in claim 9, wherein the isocyanate compound is hexamethylene diisocyanate (HDI), methylene diphenyl diisocyanate (MDI), toluene diisocyanate (TDI), isophorone diisocyanate (IPDI), 1,5-naphthalene diisocyanate (NDI), p-phenylene diisocyanate (PPDI), or a combination thereof.

12. The foam composition as claimed in claim 9, further comprising:
a surfactant.

13. A foam material, which is a product of the foam composition as claimed in claim 9 subjected to a foaming process.
